(19) United States
(12) Patent Application Publication
(10) Pub. No.: US 2008/0298258 A1
(43) Pub. Date: Dec. 4, 2008

(54) Information transfer capability discovery apparatus and techniques

(75) Inventors: Gatot Susilo, Kanata (CA); Gary John Puppa, Orleans (CA)

Correspondence Address: KRAMER & AMADO, P.C., 1725 DUKE STREET, SUITE 240, ALEXANDRIA, VA, 22314, US

(73) Assignee: ALCATEL LUCENT, Paris (FR)

(21) Appl. No.: 11/806,116

(22) Filed: May 30, 2007

(51) Int. Cl. H04L 12/26

(52) U.S. Cl. 370/248

(57) ABSTRACT

Information transfer capability discovery apparatus and techniques are disclosed. A received tracing message for tracing a communication path in a communication system is processed in some embodiments by generating and sending a response to the received tracing message. The tracing message response includes an indication of an information transfer capability of a communication link that comprises the communication path being traced by the tracing message. A further tracing message based on the received tracing message may also be forwarded in the communication system. The further tracing message may be associated with a different domain than the received tracing message in a communication system that includes multiple domains such as maintenance domains. In a multi-domain system, indications of information transfer capability could be included in further tracing messages instead of in responses.

### FIELD OF THE INVENTION

This invention relates generally to communications and, in particular, to discovering data transfer capabilities along communication paths.

### BACKGROUND

Setting a correct MTU (Maximum Transfer Unit) is generally a prerequisite for a communication network operator or service provider to configure an end-to-end service for a customer. In an Ethernet network, for example, it may be desirable to know the end-to-end MTU, an Ethernet frame size in this example, for efficient transfer of packets across the Ethernet network. This may also be a concern for packet networks in other technologies. If sent packets are larger than the smallest MTU of any node or link along an end-to-end path, then the packets must be fragmented at some point to fit this smallest MTU, which can be inefficient in terms of processing resources and bandwidth. Furthermore, it is possible that not every network element along a path would support packet fragmentation/de-fragmentation. As a result, packets might not flow on a given service.

A modern Ethernet network is rarely, if ever, only a locally administrated network such as a Local Area Network. Such networks, and similarly networks in other technologies, now tend to span across complex arrangements of multiple networks, across multiple geographic locations, and across multiple administrative and/or maintenance domains. Hence, resolving any MTU issues on networks of this scale can become a challenging task.

The IEEE 802.1ag specification provides an end-to-end Operations, Administration and Maintenance (OAM) framework for Ethernet networks that is not limited to IEEE 802.3 as an underlying media layer. Those skilled in the art will appreciate that IEEE 802.1ag and IEEE 802.3 refer to sets of specifications that are available from the Institute of Electrical and Electronics Engineers. However, the IEEE 802.1ag specification lacks MTU discovery. Furthermore, there is no known Layer 2 tool to discover MTUs in Ethernet networks.

MTU discovery can become even more difficult in complex networks, such as where a network includes multiple nested OAM domains or levels.

### SUMMARY OF THE INVENTION

Thus, there remains a need for improved MTU discovery techniques, or more generally, techniques for discovering information transfer capabilities of communication paths.

Some embodiments of the present invention leverage communication path tracing, such as the link trace protocol of the IEEE 802.1ag specification, to discover transfer capabilities along a communication path. An MTU is one example of a transfer capability that may be discovered.

Discovery and/or propagation of transfer capabilities between independently controlled domains such as nested OAM domain levels may also be provided.

According to an aspect of the invention, an apparatus includes an interface operable to enable the apparatus to exchange tracing messages for tracing communication paths in a communication system, and a tracing message processing module operatively coupled to the interface and operable to process a tracing message, received through the interface, by generating and sending through the interface a response to the received tracing message, the tracing message processing module including in the response an indication of an information transfer capability of a communication link that is associated with the apparatus and comprises a communication path being traced by the received tracing message.

The tracing message processing module may be further operable to determine whether a further tracing message based on the received tracing message is to be forwarded to other apparatus, and to forward a further tracing message based on the received tracing message through the interface to the other apparatus where a further tracing message is to be forwarded to other apparatus.

The apparatus may also include a memory, operatively coupled to the tracing message processing module, for storing information indicative of the information transfer capability, in which case the tracing message processing module may be further operable to determine the information transfer capability for the communication link by accessing the memory.

In some embodiments, the apparatus also includes a tracing message generator operatively coupled to the interface and operable to generate tracing messages and to send the generated tracing messages to other apparatus through the interface, and a response processing module operatively coupled to the interface and operable to process responses to the generated tracing messages, by determining an information transfer capability of a communication path being traced by a generated tracing message based on received responses to the generated tracing message that include indications of information transfer capabilities of communication links comprising the communication path.

The tracing messages may be Linktrace Messages (LTMs), the response may be a Linktrace Reply (LTR), and the indication of the information transfer capability may be a Type-Length-Value (TLV) triplet of the LTR.

If the tracing message is associated with one of a plurality of independently controlled domains of the communication system, the tracing message processing module may be further operable to determine whether the further tracing message is to be associated with a different domain of the plurality of domains, and to generate as the further tracing message a further tracing message associated with the different domain where the further tracing message is to be associated with the different domain.

The received tracing message may include an indication of the one of the plurality of domains. In this case, the tracing message processing module may be further operable to include, in the further tracing message, an indication of the different domain where the further tracing message is to be associated with the different domain.

In some embodiments, the tracing message processing module is further operable to include, in the further tracing message, an indication that no response is to be made to the further tracing message where the further tracing message is to be associated with the different domain.

The tracing message processing module, as noted above, may be associated with one of a plurality of independently controlled domains of the communication system, and may be further operable to determine whether the received tracing message was based on a tracing message associated with a different domain of the plurality of domains, and to include, in the further tracing message, the indication of the information transfer capability, where the further tracing message is to be forwarded to other apparatus and the received tracing message was based on a tracing message associated with a different domain, the tracing message processing module generating and sending no response to the received tracing message where the received tracing message was based on a tracing message associated with a different domain of the plurality of domains.

The tracing message processing module may be further operable to include the indication of the information transfer capability in the further tracing message where the information transfer capability is less than an information transfer capability reflected in an indication of information transfer capability in the received tracing message.

A communication system may include such an apparatus implemented at each of a plurality of sites, and at least one apparatus operable to generate a tracing message. The at least one apparatus may include a Maintenance association End Point (MEP), and each apparatus implemented at the plurality of sites may include a MEP or a Maintenance Intermediate Point (MIP).

A method is also provided, and includes receiving a tracing message for tracing a communication path in a communication system, and generating a response to the received tracing message, the response including an indication of an information transfer capability of a communication link that comprises the communication path being traced by the received tracing message.

The method may also include determining whether a further tracing message based on the received tracing message is to be forwarded, and forwarding a further tracing message based on the received tracing message where a further tracing message is to be forwarded.

In some embodiments, the method also includes generating a tracing message for tracing another communication path, receiving replies to the generated tracing message, the received replies including indications of information transfer capabilities of communication links comprising the other communication path, and determining from the received replies an information transfer capability of the other communication path.

The tracing message may be an LTM, the response may be an LTR, and the indication of the information transfer capability may be a TLV triplet of the LTR.

If the tracing message is associated with one of a plurality of independently controlled domains of the communication system, the method may also include determining whether the further tracing message is to be associated with a different domain of the plurality of domains, and generating, as the further tracing message, a further tracing message associated with the different domain where the further tracing message is to be associated with the different domain.

The received tracing message may include an indication of the one of the plurality of domains, in which case the method may also involve including, in the further tracing message, an indication of the different domain where the further tracing message is to be associated with the different domain.

In some embodiments, the method also involves including, in the further tracing message, an indication that no response is to be made to the further tracing message where the further tracing message is to be associated with the different domain.

Such a method may be implemented, for example, in apparatus associated with one of a plurality of independently controlled domains of the communication system. The method may then include determining whether the received tracing message was based on a tracing message associated with a different domain of the plurality of domains, and including, in the further tracing message, the indication of the information transfer capability, where the further tracing message is to be forwarded and the received tracing message was based on a tracing message associated with a different domain. A response to the received tracing message is generated only where the received tracing message was not based on a tracing message associated with a different domain of the plurality of domains.

In accordance with another aspect of the invention, there is provided an apparatus that includes an interface operable to enable the apparatus to exchange tracing messages for tracing communication paths in a communication system, and a tracing message processing module operatively coupled to the interface and operable to process a tracing message, received through the interface, by determining with which one of a plurality of independently controlled domains of the communication system the received tracing message is associated, determining whether a further tracing message based on the received tracing message is to be forwarded to other apparatus and is to be associated with a different domain of the plurality of domains, and generating as the further tracing message a further tracing message based on the received tracing message and associated with the different domain where a further tracing message is to be forwarded and is to be associated with the different domain.

The received tracing message may include an indication of the one of the plurality of domains, and in this case the tracing message processing module may be operable to include, in the further tracing message, an indication of the different domain where the further tracing message is to be forwarded and is to be associated with the different domain.

The tracing message processing module may be further operable to include, in the further tracing message, an indication that no response is to be made to the further tracing message where the further tracing message is to be associated with the different domain.

If the tracing message processing module is associated with one of the plurality of domains, it may be further operable to determine whether the received tracing message was based on a tracing message associated with a different domain than the tracing message processing module, to include, in the further tracing message, an indication of an information transfer capability of a communication link that is associated with the apparatus and comprises a communication path being traced by the received tracing message, where the further tracing message is to be associated with a different domain and the received tracing message was based on a tracing message associated with a different domain than the tracing message processing module, and to generate and send through the interface a response to the received tracing message, the response comprising the indication, where the received tracing message was not based on a tracing message associated with a different domain than the tracing message processing module.

In some embodiments, the tracing message processing module is further operable to include the indication of the information transfer capability in the further tracing message where the information transfer capability is less than an information transfer capability reflected in an indication of information transfer capability in the received tracing message.

A communication system may include such an apparatus implemented at each of a plurality of sites, and at least one apparatus operable to generate a tracing message, with the at least one apparatus including a MEP, and each apparatus implemented at the plurality of sites including a MEP or a MIP.

A method is also provided, and includes receiving a tracing message for tracing communication paths in a communication system, the tracing message being associated with one of a plurality of independently controlled domains of the communication system, determining whether a further tracing message based on the received tracing message is to be forwarded and is to be associated with a different domain of the plurality of domains, and generating as the further tracing message a further tracing based on the received tracing message and associated with the different domain where a further tracing message is to be forwarded and is to be associated with the different domain.

If the received tracing message includes an indication of the one of the plurality of domains, the method may also involve including, in the further tracing message, an indication of the different domain where the further tracing message is to be forwarded and is to be associated with the different domain.

The method may also involve including, in the further tracing message, an indication that no response is to be made to the further tracing message where the further tracing message is to be forwarded and is to be associated with the different domain.

Such a method may be implemented, for example, in apparatus associated with one of the plurality of domains. In this case, the method may also involve determining whether the received tracing message was based on a tracing message associated with a different domain than the apparatus, including, in the further tracing message, an indication of an information transfer capability of a communication link that is associated with the apparatus and comprises a communication path being traced by the received tracing message, where the further tracing message is to be forwarded and is to be associated with a different domain and the received tracing message is associated with a different domain than the apparatus, and generating and sending a response to the received tracing message, the response comprising the indication, where the received tracing message was not based on a tracing message associated with a different domain than the apparatus.

Other aspects and features of embodiments of the present invention will become apparent to those ordinarily skilled in the art upon review of the following description.

### BRIEF DESCRIPTION OF THE DRAWINGS

Examples of embodiments of the invention will now be described in greater detail with reference to the accompanying drawings.

FIG. 1 is a block diagram of a communication system.

FIG. 2 is a block diagram of a communication system employing an existing technique for determining MTUs.

FIG. 3 is a block diagram of a communication system in which an embodiment of the invention is implemented.

FIG. 4 is a block diagram of an apparatus according to an embodiment of the invention.

FIG. 5 is a block diagram of another communication system in which an embodiment of the invention is implemented.

FIG. 6 is a flow diagram illustrating a method according to another embodiment of the invention.

FIGS. 7A and 7B are block diagrams illustrating message formats according to embodiments of the invention.

### DETAILED DESCRIPTION OF PREFERRED EMBODIMENTS

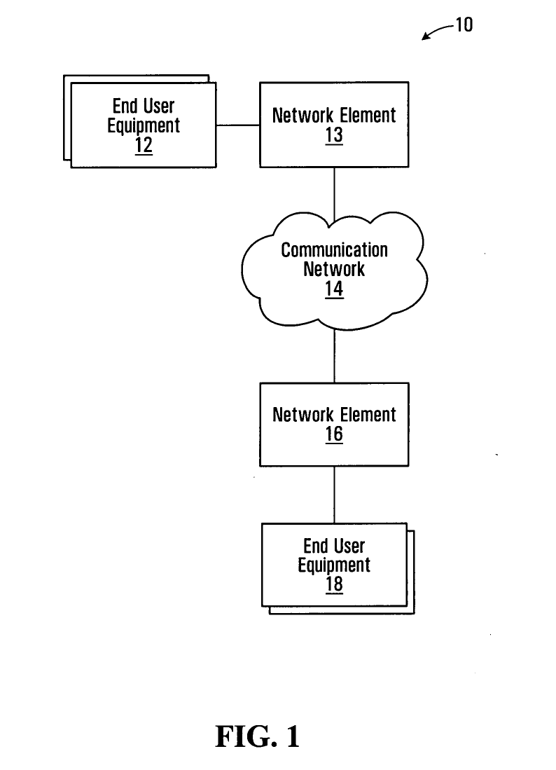

FIG. 1 is a block diagram of a communication system 10, in which some embodiments of the invention may be implemented. The communication system 10 includes end user communication equipment 12, 18, network elements 13, 16, and a communication network 14. Although many installations of end user equipment 12, 18 and network elements 13, 16 may be connected to the communication network 14, only two examples of each of these components have been labelled in FIG. 1 to avoid overly complicating the drawing. It should therefore be appreciated that the system of FIG. 1, as well as the contents of the other drawings, are intended solely for illustrative purposes, and that the present invention is in no way limited to the particular example embodiments explicitly shown in the drawings and described herein. In general, embodiments of the invention may include fewer, further, or different components interconnected in a similar or different order than shown.

The end user equipment 12, 18 represents communication equipment that is configured to transmit and/or receive communication traffic, which may include any type(s) of information, such as data files, pictures, video, voice, etc. Although shown as being directly connected to the network elements 13, 16, it will be apparent that end user equipment 12, 18 may communicate with the network elements 13, 16 through other access components (not shown).

Switches and routers are illustrative of the types of communication equipment represented by the network elements 13, 16. The network elements 13, 16 provide access to the communication network 14 and thus have been shown separately in FIG. 1 for illustrative purposes. The communication network 14 may also include, in addition to the border or edge network elements 13, 16, core network elements that route communication traffic through the network.

Many different types of end user, access, and network communication equipment, as well as the operation thereof, will be apparent to those skilled in the art. In general, communication traffic originating with end user equipment 12, 18, and/or possibly other sources of communication traffic, for transfer to a destination through the communication network 14 is received by a network element 13, 16, translated between different protocols or formats if necessary, and routed through the communication network. Embodiments of the invention are not limited to any particular types of communication equipment, transfer mechanisms, or protocols.

As noted above, it may be useful for a service provider or network operator to know the information transfer capabilities that may exist along a communication path before communication traffic is placed on that path. The path itself may or may not be established when transfer capabilities are being determined. For example, transfer capabilities for a path may be determined by communicating with network elements through which the path could be established. Thus, references herein to a path should be interpreted as including paths that have or have not already been established.

Since MTUs are generally well known in the art, MTUs are used for illustrative purposes throughout the present application. It should be appreciated, however, that the techniques disclosed herein could potentially be applied to other transfer capabilities or characteristics than MTUs.

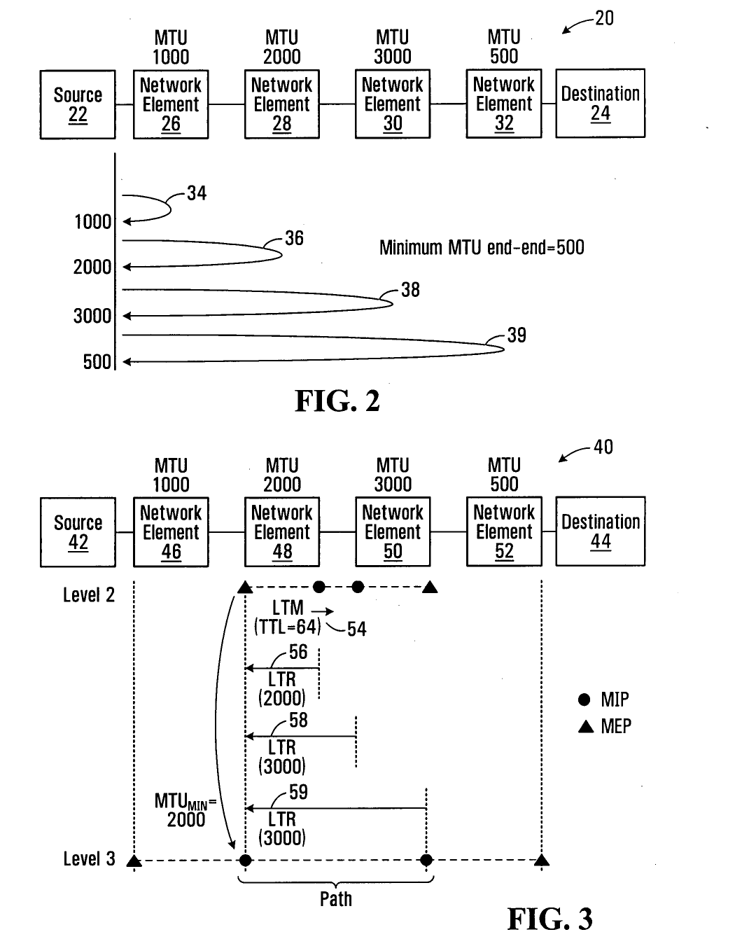

Ping- or query-based techniques for determining MTUs may be available, for example, at Layer 3 in the case of Internet Control Message Protocol (ICMP) ping or at Layer 2.5 in the case of Label Switched Path (LSP) ping. FIG. 2 is a block diagram of a communication system employing such a technique for determining MTUs.

In the system 20, a service provider or network operator may wish to set up communications between a source 22 and a destination 24 through the network elements 26, 28, 30, 32, each of which has a respective MTU setting, such as a number of bytes. Although a network element may have different MTU settings for ingress and egress interfaces, the ingress and egress interfaces are assumed for simplicity to have the same MTU setting in the example shown. Query or ping messages are sent to each of the network elements 26, 28, 30, 32, from an operator terminal (not shown), for example. In response to a ping or query message, each network element 26, 28, 30, 32 sends a reply that specifies its MTU setting.

Query/reply exchanges are illustrated at 34, 36, 38, 39. When replies have been received from each network element, the service provider or network operator can determine the maximum MTU that can be used end-to-end between the source 22 and the destination 24, which is the minimum MTU of the network elements 26, 28, 30, 32, is 500 bytes.

In accordance with one aspect of the invention, the IEEE 802.1ag framework of path discovery (i.e., the Linktrace Protocol) is used to also discover the MTU of each link along an end-to-end path. The MTU of each link, or an MTU of the path, may be reported to an originating node or system to be examined by operator or service provider personnel or otherwise processed.

As used herein, a “link” is intended to convey the notion of a portion of a communication path. This may, but need not necessarily, include a connection between different components or devices. In the case of MTUs, for example, ingress and egress interface MTU settings could be considered one form of indications of the information transfer capabilities of communication links that are connected to those interfaces. The term “path” includes one or more links, and is intended to refer to an end-to-end path between two devices or systems, such as between two network elements. A path need not be a path between installations of end user equipment or customer equipment, although in many cases it is expected that a service provider or network operator would use the techniques disclosed herein to investigate the information transfer capabilities of their customer-to-customer paths. References to links and paths should be interpreted accordingly.

FIG. 3 is a block diagram of a communication system in which an embodiment of the invention is implemented. The communication system 40 includes a source 42, a destination 44, and network elements 46, 48, 50, 52, with example MTU settings as shown. For illustrative purposes, a multi-domain Ethernet network is shown in FIG. 3, with the network elements 46, 52 being part of a level 3 domain and the network elements 48, 50 being part of a level 2 domain.

Those skilled in the art will be familiar with the IEEE 802.1ag specification, which allows up to 8 nested Maintenance Domain (MD) levels. These levels are delineated by Maintenance association End Points (MEPs), which are the source/sink points for Ethernet OAM packets. A lower MD level includes components that provide service to a higher MD level, although the higher MD level does not have visibility into the internal structure or arrangement of the lower MD level components beyond the interfaces, called Domain Service Access Points (DSAPs) through which the lower MD level provides service to the higher MD level. Each MD level is administrated and managed separately, such that components in an MD level can be managed and controlled only within that MD level, and not from a higher or lower MD level. MD levels may thus be considered a form of independently controlled domains of a communication system. In other types of communication systems, different forms of independent operational, control, and/or maintenance domains may be provided.

Maintenance Intermediate Points (MIPs) are also shown in FIG. 3. Since those skilled in the art will be familiar with the IEEE 802.1ag specification, MEPs, MIPs, their provisioning/configuration and typical operation, and the Linktrace Protocol are described herein only to the extent necessary to illustrate embodiments of the invention. The detailed disclosure of embodiments of the invention provided herein would enable a person skilled in the art to implement the invention by modifying the operation of MEPs, MIPs, and/or the Linktrace protocol, or through other technologies than IEEE 802.1ag.

In FIG. 3, the MEPs at the network elements 46, 52 are configured at level 3. Both a MEP at level 2 and a MIP at level 3 are configured at the DSAP interfaces at the network elements 48, 50. The MEPs at level 2 delineate the OAM path between the network elements 48, 50 at level 2.

MIPs are also configured at the internal interfaces of the network elements 48, 50 at level 2.

In accordance with an embodiment of the invention, to discover the MTUs between the network elements 48, 50 for a communication path through the level 2 domain, a Linktrace Message (LTM) is multicasted by the MEP of the network element 48. The MIPs along the path and the MEP at the network element 50 reply to the LTM with Linktrace Reply (LTR) messages that include their respective MTUs. An indication of an MTU might be encoded in a new Type-Length-Value (TLV) triplet of the LTR. No such indication of MTU is currently provided in the IEEE 802.1ag specification.

The network element 48 may then determine the minimum MTU, which might be a maximum packet size for instance, for the path between the network elements 48, 50.

In the example shown, the minimum MTU would be 2000 bytes. In a multiple-domain communication system 40, one or more MTUs may be “reported” from the level 2 MEP at the network element 48 to the MIP at the next higher level 3.

This reporting may be performed manually, such as during commissioning of the MIP at level 3. Hence, the MTU information for the path at level 2, which may in turn be considered a link in a path between the source 42 and the destination 44, is readily available at level 3. The level 3 MIP at the network element 48 can then include an indication of the minimum MTU for the level 2 path in an LTR 30 it sends in reply to an LTM received from the level 3 MEP at the network element 46. Such a level 3 LTM would be generated by the MEP at the network element 46, for example, when the minimum MTU for a communication path between the source 42 and the destination 44 is to be determined.

The operation of determining the minimum MTU in the above example may be performed by a component of the network element 48 other than the MEP at the DSAP interface. Since MTU discovery is not provided by MEPs according to current versions of the IEEE 802.1ag specification, this type of processing might be handled by a separate component of the network element 48. However, in other implementations, a component that participates in MTU discovery, or more generally transfer capability discovery, might also perform this type of further processing. Thus, in general, a level 2 tracing message response processing module might report either a minimum transfer capability for a level 2 path or multiple link transfer capabilities to a level 3 tracing message processing module. The level 3 module can then respond to a level 3 tracing message with the minimum transfer capability for a level 2 path that is part of the level 3 path being traced by the tracing message. The minimum capability reported by the level 3 module might have been received from an underlying level 2 module or determined on the basis multiple link capabilities reported by the level 2 module.

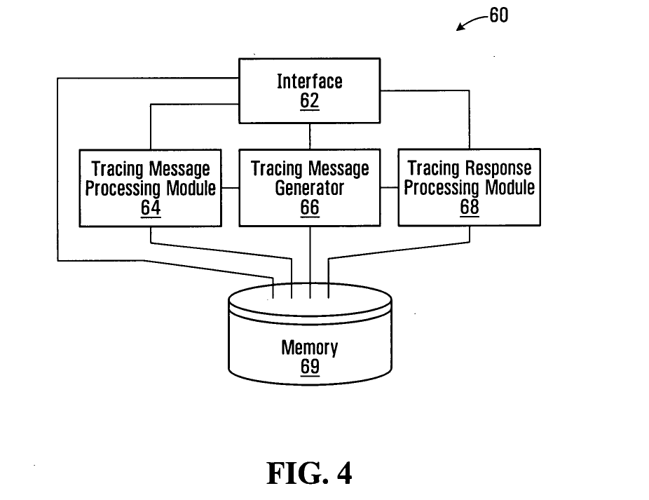

FIG. 4 is a block diagram of an apparatus according to an embodiment of the invention. The apparatus 60 includes an interface 62, a tracing message processing module 64 operatively coupled to the interface, a tracing message generator 66 operatively coupled to the interface and to the tracing message processing module, a tracing response processing module 68 operatively coupled to the interface and to the tracing message generator, and a memory 69 operatively coupled to the interface, to the tracing message processing module, to the tracing message generator, and to the tracing response processing module.

A communication system device or component in which or in conjunction with which the apparatus 60 is implemented may include other components in addition to those shown in FIG. 4. It should be appreciated that only components involved in transfer capability discovery have been explicitly shown in the apparatus 60. It should also be appreciated that not all of the components shown in FIG. 4 need necessarily be provided in every embodiment of the invention. For example, although a MEP can generate LTMs and LTRs and also receive LTMs and LTRs, a MIP can typically only generate LTRs and forward received LTMs or slightly modified versions of received LTMs. A MIP-based embodiment of the invention therefore might not include a tracing message generator 66 or a tracing response processing module 68.

Thus, the apparatus 60 is representative of one illustrative embodiment of the invention. Other embodiments may be implemented using further, fewer, or different components than shown in FIG. 4, with similar or different interconnections.

The types of connections through which the components of FIG. 4 are operatively coupled may, to at least some extent, be implementation-dependent. Communication equipment components often use various types of physical connectors and wired connections such as midplane and backplane conductors, although the present invention is in no way limited to wired connections. In the case of cooperating software functions, for example, an operative coupling may be through variables or registers, and thus be an indirect coupling rather than a direct physical coupling.

The interface component 62 represents one or more interfaces, and possibly interfaces of multiple different types, that enable the apparatus 60 to at least exchange tracing messages such as LTMs with other apparatus. Although only a single interface component 62 is shown in FIG. 4, multiple interfaces, and potentially different types of interfaces, may be provided in some embodiments to exchange tracing messages and/or tracing responses with other apparatus. An interface 62 that is used to exchange tracing messages and/or responses need not necessarily be a dedicated interface. Such an interface might also be used for transfer of other messages and information. For example, a communication interface of a network element might be used for transfer of both communication traffic and tracing messages.

In general, the number and types of interfaces may vary depending on the communication system and communication equipment in conjunction with which the apparatus 60 is implemented. Although a MIP and a MEP configured on the same communication interface of a network element will use that interface for LTMs and LTRs, for example, different interfaces may be provided for exchanging tracing messages and responses in other embodiments. Those skilled in the art will be familiar with these and other examples of interfaces that may be suitable for these purposes.

One or more memory devices may be used to implement the memory 69. Solid state memory devices are common in communication and computing equipment, although other types of memory devices, including devices for use with movable or even removable storage media, may also or instead be used.

As described in further detail below, the tracing message processing module 64, the tracing message generator 66, and the tracing response processing module 68 may be involved in discovering and/or propagating information transfer capabilities. At least these components may be implemented using hardware, firmware, software for execution by one or more processing elements, or some combination thereof. Any or all of devices such as microprocessors, microcontrollers, Programmable Logic Devices (PLDs), Field Programmable Gate Arrays (FPGAs), Application Specific Integrated Circuits (ASICs), Network Processors (NPs), and other types of “intelligent” integrated circuits may be suitable for this purpose.

Given the many possible options for implementing at least the components 64, 66, 68, these components are described primarily in terms of their functions. Based on the functional descriptions, a person skilled in the art will be enabled to implement techniques according to embodiments of the invention in any of various ways.

As noted above, the interface 62 is operable to enable the apparatus 60 to exchange tracing messages for tracing communication paths in a communication system. An LTM is one example of such a tracing message. The tracing message processing module 64, which might include a Linktrace Responder of a MEP or a MIP Half Function (MHF) in some embodiments, is operable to process a tracing message that is received through the interface 62. The tracing message processing module 64 may generate and send, through the interface 62, a response to the received tracing message. In accordance with an aspect of the invention, the tracing message processing module 64 includes in the response an indication of an information transfer capability of a communication link that is associated with the apparatus 60 and is part of a communication path being traced by the received tracing message. As noted above, this indication might be encoded in a TLV of an LTR, for instance.

In the case of an IEEE 802.1ag-based implementation, a communication link associated with the apparatus 60 could be a link associated with the communication interface on which a MEP or MIP is configured. The indication might then be the MTU setting of that interface.

It should be noted that not all received tracing messages would necessarily be processed by the tracing message processing module 64. A tracing message might not be processed if a network element that receives the tracing message is not able to communicate with a target address or destination specified in the tracing message, for example. In a multi-domain system, a MEP or MIP that receives a tracing message associated with a different domain or level might not process that tracing message. However, some possible options for inter-domain tracing message processing are described in further detail below.

The tracing message processing module 64 may determine whether a further tracing message based on the received tracing message is to be forwarded to other apparatus, and if so, forwards a further tracing message, based on the received tracing message, through the interface 62. The forwarded tracing message may be the same as the received tracing message in some embodiments, although a tracing message may be modified before forwarding. A target address for a communication path being traced might not be changed, for example, whereas other information in a received tracing message might be revised. In the case of an LTM, each MIP that forwards an LTM decrements the LTM TTL field according to current IEEE 802.1ag specifications, and this function could be maintained in embodiments of the invention.

Information indicative of the information transfer capability to be reported in a tracing response could be stored in the memory 69. A minimum MTU for a link or path associated with the apparatus 60 could be stored in the memory 69 when a MIP is being configured, for instance, as described above. The tracing message processing module 64 may then determine the information transfer capability for a communication link by accessing the memory 69.

The tracing message generator 66 is operable to generate tracing messages and to send the generated tracing messages to other apparatus through the interface 62. This component might include a MEP Linktrace Initiator in IEEE 802.1ag-based embodiments.

An apparatus that includes a tracing message generator 66 may also in most cases include a tracing response processing module 68. The tracing message generator 66 and the tracing response processing module 68 may work together to associate responses received through the interface 62 with the tracing messages to which they correspond. As those skilled in the art will appreciate, a MEP Linktrace Initiator also handles LTRs that are received in response to an initiated LTM.

According to an aspect of the invention, the tracing response processor 68 is operable to process responses to generated tracing messages by determining an information transfer capability of a communication path traced by a generated tracing message. This determination is made on the basis of received responses that include indications of information transfer capabilities of communication links that make up the communication path. This module might make a minimum MTU determination, for example.

In a multi-domain system, transfer capability discovery becomes more complex. In accordance with a further aspect of the invention, tracing messages are also used to resolve transfer capabilities in different domains. Considering the example of an Ethernet network with nested MD levels, LTMs may be used to resolve the minimum MTU for a communication path at lower MD levels. Minimum MTUs for lower level paths, which are in turn parts of a higher level path, are reported back to the originating MEP by a Maintenance Point (MP), i.e., a MIP or a MEP, at the MD level at which the LTM originated. To resolve the minimum MTU at a lower MD level, the MIP at a higher level converts an LTM to run at the lower MD level.

This converted LTM is a “no-reply LTM” in some embodiments. Along the path at the lower MD level, each MIP updates the no-reply LTM with its MTU, and a reply (i.e., an LTR) is not generated. When the no-reply LTM reaches a MIP or a MEP at the original MD level, the no-reply LTM is processed and an LTR is generated back to the originating MEP. The LTR includes at least the ingress MTU information from the received no-reply LTM message, and may also include egress MTU information where the no-reply LTM is received by a MIP at the original MD level.

A minimum MTU may thus be resolved at a lower MD level along the path of the LTM, providing an accurate result that reflects any rerouting at the lower level(s). In the above example of manual inter-level reporting, a manually reported MTU might not be accurate after rerouting of a communication path at the lower level. Furthermore, only an MP at the MD level where the LTM originated replies to the LTM with an LTR to the originating MEP. The operator of the higher MD level still cannot see the topology of the lower MD level. Hence, this also meets the spirit of administrative maintenance domains of the IEEE 802.1ag specification.

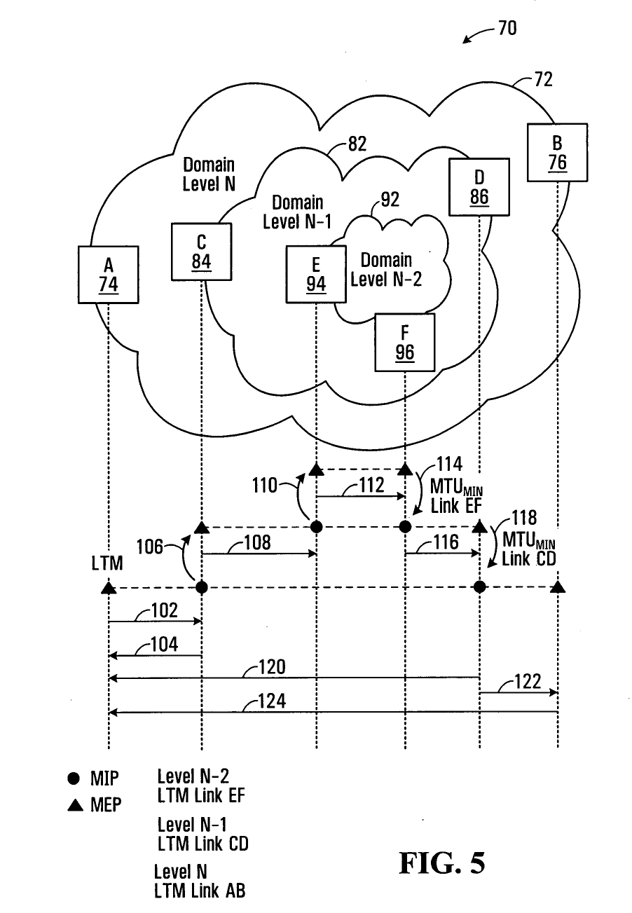

This type of multi-level resolution is illustrated in the block diagram of FIG. 5. The system 70 shown in FIG. 5 includes three nested domains 72, 82, 92 at levels N, N−1, N−2. Only two network elements have been shown in each domain in order to avoid overly complicating the drawing. The domain 72 at level N includes network elements A 74 and B 76, the domain 82 at level N−1 includes network elements C 84 and D 86, and the domain 92 at level N−2 includes network elements E 94 and F 96. Information capability discovery operations are shown at the bottom of FIG. 5

Multi-domain discovery is shown in FIG. 5 and described below by way of illustrative example, specifically the example of the network element A attempting to determine an information transfer capability of a communication path between A and B. An LTM generated by the MEP at network element A is multicasted and received by the level N MIP at the network element C, as shown at 102. The level N MIP at the network element C processes the LTM, responds to the LTM with an LTR at 104, “pushes” an indication of the current MD level (N), which may have been included in the original LTM, into an MD Level Stack TLV, and converts the LTM into a no-reply LTM at MD Level N−1 in accordance with an embodiment of the invention. This conversion might involve changing an indication of level N in the original LTM to an indication of level N−1, so that the converted no-reply LTM may appear as though it originated at level N−1, even though it is actually associated with level N. MEPs and MIPs at level N−1 will then process the converted LTM. A flag or other indication may also be added to an LTM during the conversion process to allow the converted LTM to be identified as a no-reply LTM.

The conversion at the network element C is shown in FIG. 5 at 106, and the converted no-reply LTM is forwarded from the network element C, as shown at 108.

This process is conducted again at the level N−1 MIP at the network element E, as shown at 110, 112. When the twice-converted no-reply LTM reaches the level N−2 MEP at the network element F, the MEP pops the MD Level Stack TLV to convert the no-reply LTM into a no-reply LTM at the popped MD level, and passes the converted no-reply LTM to the next-level MIP, as shown at 114, 116. This reverse conversion process is again conducted at the level N−1 MEP and the level N MIP at the network element D, as shown at 118.

Only an MP at the an MD level lower or equal to the original MD level processes an LTM or no-reply LTM. In the case of a no-reply LTM, an MP does not send a reply to the LTM, but instead includes an indication of MTU setting in its converted no-reply LTM. In some embodiments, an MP only includes an MTU setting in a converted no-reply LTM before forwarding if its own MTU setting is lower than the MTU currently included in the no-reply LTM. Each MP at a lower level than an original LTM could instead include its MTU in the no-reply LTM, with a MEP that is to pass an LTM to a higher level then determining the minimum MTU from those in the no-reply LTM. Unlike conventional MPs, MEPs and MIPs implementing embodiments of the invention do not reply to no-reply LTMs, but rather include indications of their MTUs in no-reply LTMs as they are forwarded between network elements along a communication path. This provides for discovery of a minimum MTU along the portion of a path at each level.

As shown at 114, the minimum MTU for the EF link through the level N−2 domain is provided to the level N−1 MIP at the network element F. This level N−1 MIP provides the minimum MTU for the EF link, or possibly its own egress MTU if lower, in a no-reply LTM at 116. The minimum MTU for the CD path at the level N−1 is determined at the network element D and propagated up to the level N MIP, as shown at 118. Thus, minimum MTUs between MEPs of a path at a domain level are propagated to the corresponding MIPs at the next higher level.

Any of several mechanisms may be used in determining MTUs for nested paths. As shown in FIG. 5, MUTMIN for the EF link is reported by the MIP at node F to the MEP at node D. MTUMIN for the CD path is determined at node D based on the EF link MTUMIN and MTUs for the CE and FD links. The CE interface MTU at node C, for example, could be included by the level N−1 MEP at node C in the no-reply LTM it sends at 108. The MTUMIN reported at 114 is then actually the minimum MTU for the CF link. A stacked MTU TLV could instead be used, with each level recording its own minimum MTU. The level N−1 MEP at node C, the level N−1 MIP at node E, the level N−1 MIP at node F, and the level N−1 MEP at node D might all update the same MTU value in a stacked MTU TLV to record the minimum TLV for level N−1. The MEPs at nodes E and F would similarly update another MTU value in a stacked MTU TLV in such an implementation. The level N MIP at node D then receives, from the level N−1 MEP at node D, the level N−2 EF link minimum MTU and the level N−1 CD link minimum MTU in the stacked MTU TLV.

Execution of no-reply LTMs on the path CD at OAM level N−1 initiates MTU discovery between the MEPs at nodes C and D, which references the minimum MTU discovered for path EF at level N−2. The minimum MTU for path CD is then propagated to the corresponding MIPs for this path at the next higher level (level N). The process continues for path AB at level N, and so on, for all path segments or links at all OAM domain levels.

The level N MIP at the network element D sends an LTR to the originating level N LTM a the network element A, and also forwards an LTM to the level N MEP at the network element B. This level N MEP responds to the level N MEP at the network element A with an LTR. These operations are shown at 120, 122, 124.

The above example refers to conversion of LTM messages between domain levels. However, it should be appreciated that other mechanisms than conversion could be used. A higher-level MIP, for example, could itself convert an LTM into a no-reply LTM to be run at the next lower MD level, or invoke a no-reply LTM initiation process by a lower-level MEP. Thus, a no-reply LTM could be a newly generated LTM rather than a converted LTM. The normal operation of a MIP could be modified to enable a MIP to detect an underlying MEP and to invoke a linktrace operation at that MEP. The MIP in this case is effectively behaving as a user who triggers a linktrace procedure at the lower MD level. As a result, a consistent behaviour or procedure as per IEEE 802.1ag can be achieved in some embodiments, where a MEP always originates LTMs. Each no-reply LTM, however, might include the same originating node information as the original LTM sent at 102 so that level N MPs respond to the correct node.

In order to implement the above multi-domain discovery mechanism in an Ethernet network, the following features may generally be preferred:
Within a maintenance domain that provides a service to a higher maintenance domain, for each path between two nodes in the maintenance domain, a pair of MEPs is configured. For example, a pair of MEPs at the physical MD level (i.e., level 1) between two nodes is configured.
A MIP at the next higher MD level is configured above each MEP. Hence, MEPs always delineate between two different MD levels.

A more verbose version of MTU discovery may be preferred at a lower MD level in some embodiments. In this case, the above multi-level discovery mechanism may be extended such that the MIP at a lower MD level may reply to the no-reply LTM with an LTR to the originating MEP. This yields not only MTU discovery, but also MD discovery as well. The trade-off is that this MTU discovery tool may expose the topology of MD at the lower MD level. This would not be an issue if all MDs, while being independently controlled, are maintained/owned by the same operator, for example.

Referring now again to FIG. 4, the apparatus 60 may also be operable to participate in multi-domain discovery. As will be apparent from the foregoing description of FIG. 5, a tracing message received through the interface 62 may be associated with one of a plurality of independently controlled domains of a communication system. The tracing message processing module 64 may thus be operable to determine whether a further tracing message, a no-reply LTM in the above example, is to be forwarded into a different domain, and if so, to forward the further tracing message through the interface 62 into the different domain. The tracing message to be forwarded may be generated by the tracing message processing module 64 itself in some embodiments. If an apparatus also includes a tracing message generator 66, then the tracing message processing module 64 might instead signal the tracing message generator 66 to generate a tracing message for forwarding based on a received tracing message. As noted above, a forwarding tracing message includes an MD level stack in some embodiments.

A tracing message in a multi-domain system may include an indication of the domain with which the tracing message is associated. The tracing message processing module 64 or the tracing message generator 66 may then include in the forwarding tracing message an indication of the different domain into which the forwarding tracing message is to be forwarded.

An indication that no response is to be made to the forwarding tracing message may also be provided in the message itself, so that a tracing message processing module 64 in an apparatus that receives the forwarding tracing message includes its capability indication in a further tracing message instead of in a tracing response message.

As described above, an MP responds to a no-reply LTM only if it is at the originating level of the original LTM, as identified from the MD level stack in some embodiments. Thus, the tracing message processing module 64 may determine whether a received tracing message is associated with a different domain, and if so, to include the indication of information transfer capability in a forwarding tracing message. Otherwise, the tracing message processing module 64 is associated with the same domain as the received tracing message, and the module generates and sends a response to the received tracing message.

In some embodiment, only a minimum transfer capability is forwarded in tracing messages. The tracing message processing module 64 may thus include an indication of a local information transfer capability in a forwarding tracing message if the local information transfer capability is less than an information transfer capability reflected in an indication of information transfer capability in the received tracing message.

It should be noted that although transfer capability discovery through a tracing mechanism and a multi-domain mechanism have been described above with reference to the same apparatus 60, these aspects of the invention may be implemented independently.

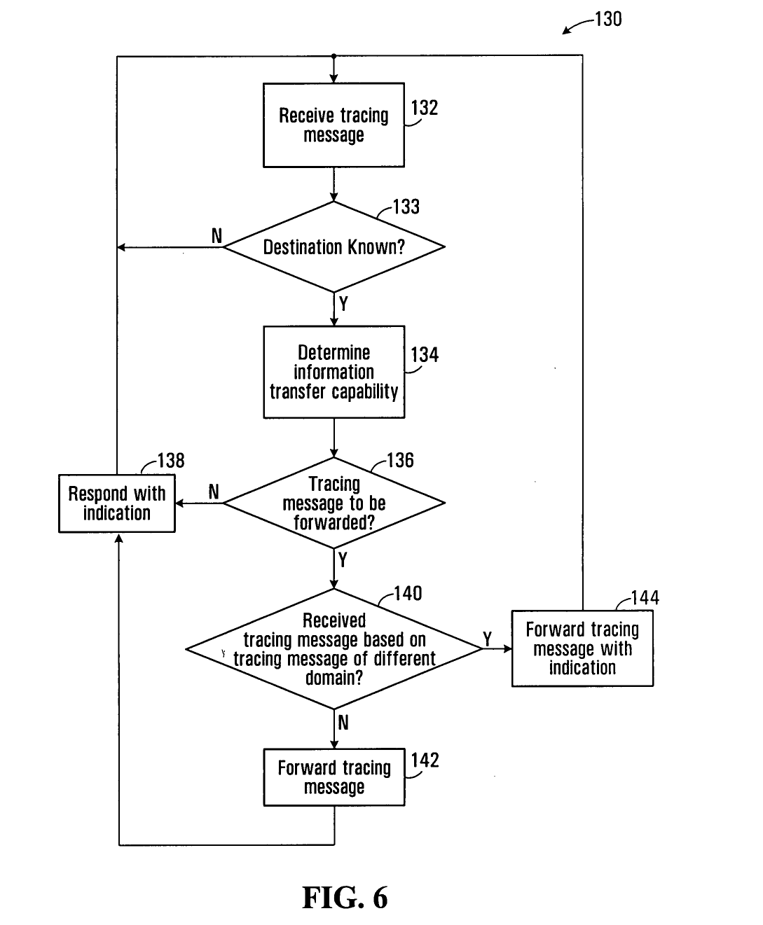

FIG. 6 is a flow diagram illustrating a method according to another embodiment of the invention. The method 130 includes receiving at 132 a tracing message for tracing a communication path in a communication system. In the case of an LTM as the tracing message, the tracing message received at 132 is multicast traffic, and a MIP will forward and respond to the received LTM with an LTR only if the MIP is able to forward the LTM to a target MEP whose destination address is specified in the LTM. An LTR will not be generated and an LTM will not be forwarded when a MIP does not know how to forward the LTM to target MEP. In general, only a MIP that knows how to forward the LTM to target MEP (i.e., the destination address of the target MEP has been learned and programmed into a forwarding database of the network element where the MIP resides) and the target MEP itself can respond with an LTR. Otherwise, the LTM is simply discarded and no response is generated.

This is represented in FIG. 6 at 133. If the destination or path endpoint associated with the received tracing message, which is a target MAC address in the case of an LTM, is not known, then processing returns to 132 until another tracing message is received. No response to the tracing message is generated, and no tracing message based on the received tracing message is forwarded.

An information transfer capability of a communication link that is part of the communication path being traced by the received tracing message is determined at 134 if the destination is known.

The method proceeds at 136 with a determination of whether a further tracing message based on the received tracing message is to be forwarded, and if not, a response to the tracing message, including an indication of the information transfer capability determined at 134, is generated at 138. This would be the case at the target MEP, for example, which would respond to a received LTM, but would not forward the LTM.

If a tracing message based on the received tracing message is to be forwarded, a determination may be made at 140 as to whether the received tracing message was based on a tracing message associated with a different domain. If the received tracing message was based on a tracing message associated with a different domain, then a further tracing message based on the received tracing message is forwarded at 142 and a response to the received tracing message is generated at 138. As noted above, the response generated at 138 includes an indication of the information transfer capability determined at 134.

After a response is generated at 138, processing returns to 132 until another tracing message is received.

If the received tracing message was based on a tracing message associated with a different domain, as might be determined by determining whether the received tracing message includes an MD level stack, then the transfer capability indication determined at 134 is included in a forwarding tracing message, which is forwarded at 144. Processing then returns to 132.

The method 130 is illustrative of one embodiment of the invention. Other embodiments may include fewer, further, or different operations, performed in a similar or different order, than shown. These and other operations may also be performed in any of various ways.

For example, tracing messages may also be generated to trace other communication paths. As will be apparent from the foregoing, the forwarding at 142 and/or 144 may involve forwarding a tracing message into a different domain of a communication system. The order in which operations are performed may also vary, such that a response may be generated at 138 before a further tracing message is forwarded at 142, for instance.

Further variations of the method 130 may be or become apparent to those skilled in the art, from the foregoing apparatus and communication system descriptions, for instance.

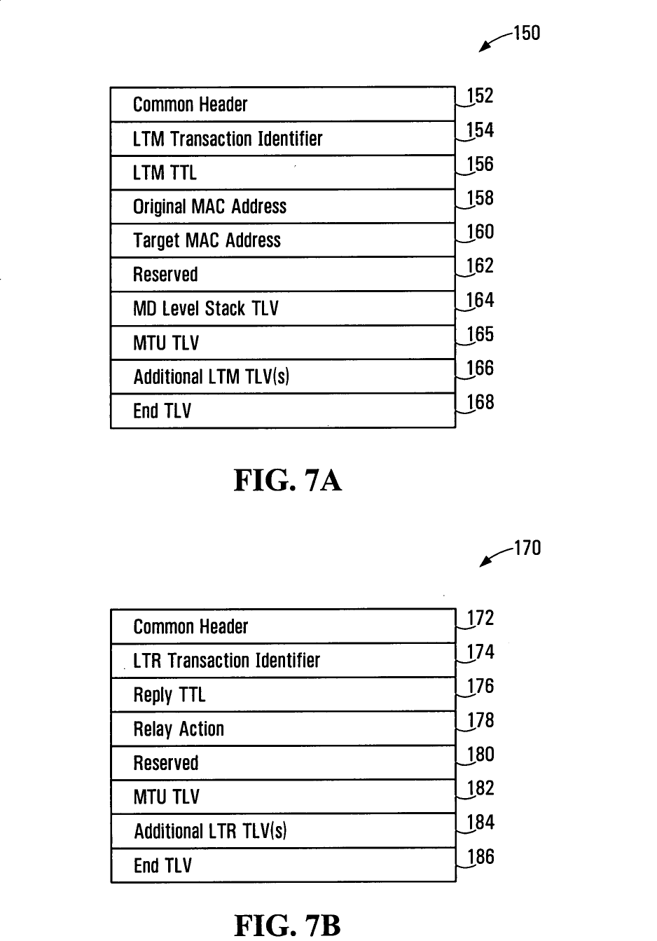

FIGS. 7A and 7B are block diagrams illustrating message formats according to embodiments of the invention. As those skilled in the art will appreciate, the example message formats shown in FIGS. 7A and 7B relate to IEEE 802.1ag. Similar or different message formats may be used for other protocols.

FIG. 7A shows an example of a tracing message 150. The tracing message 150 is an LTM, and includes a common header 152, an LTM transaction identifier field 154, an LTM TTL field 156, an original MAC address field 158, a target MAC address field 160, a reserved field 162, an MD level stack field 164, a TLV in the example shown, an MTU field 165, also a TLV in the example shown, one or more additional TLV fields 166, and an end TLV 168. Apart from the MD level stack TLV 164, and the MTU TLV 165, which may be a stacked or nested TLV in some embodiments, the data fields shown in FIG. 7A may be as defined in current IEEE 802.1ag specifications. As described in detail above, the presence of an MD level stack TLV 164 in a tracing message may be used to identify an LTM as a no-reply LTM. MTUs along lower MD levels may be recorded in the MTU TLV 165 as a no-reply LTM is passed between MPs during multi-domain tracing and MTU discovery.

FIG. 7B shows an example of a tracing response message 170. The tracing response message 170 is an LTR, and includes a common header 172, an LTR transaction identifier field 174, a reply TTL field 176, a relay action field 178, a reserved field 180, an MTU field 182, a TLV in the example shown, one or more additional TLV fields 184, and an end TLV 186. The data fields shown in FIG. 7B, with the exception of the MTU TLV 182, may be as defined in current IEEE 802.1ag specifications. MTUs are included in the LTR 170 in the MTU TLV 182.

The examples shown in FIGS. 7A and 7B are intended solely for illustrative purposes. Other embodiments may use similar or different message formats that include the further, fewer, or different data fields arranged in a similar or different order than shown.

As Ethernet networks become more widely deployed as a transport to deliver end-to-end services to customers, such as Triple Play services, operators may require a proper Ethernet OAM tool to isolate MTU related issue. Embodiments of the present invention may be used by operators to discover MTUs for a given end-to-end path. This may be valuable in isolating MTU issues and locating a bottleneck in an Ethernet network. Overall, embodiments of the invention may result in reduced operating expenditures for providing services in Ethernet networks, and/or in other networks.

What has been described is merely illustrative of the application of principles of embodiments of the invention. Other arrangements and methods can be implemented by those skilled in the art without departing from the scope of the present invention.

For example, the divisions of functions shown in FIG. 4 and similarly the flow of operations in FIG. 6 are intended solely for illustrative purposes. The present invention is in no way limited to the specific examples shown in the drawings and described above.

IEEE 802.1ag is also intended to be illustrative and not limiting. The techniques disclosed herein may be adapted to other types of networks and tracing mechanisms as well.

In addition, although described primarily in the context of methods and systems, other implementations of the invention are also contemplated, as instructions stored on a computer-readable medium, for example.

We claim:

1. An apparatus comprising:
an interface operable to enable the apparatus to exchange tracing messages for tracing communication paths in a communication system; and
a tracing message processing module operatively coupled to the interface and operable to process a tracing message, received through the interface, by generating and sending through the interface a response to the received tracing message, the tracing message processing module including in the response an indication of an information transfer capability of a communication link that is associated with the apparatus and comprises a communication path being traced by the received tracing message.

2. The apparatus of claim 1, wherein the tracing message processing module is further operable to determine whether a further tracing message based on the received tracing message is to be forwarded to other apparatus, and to forward a further tracing message based on the received tracing message through the interface to the other apparatus where a further tracing message is to be forwarded to other apparatus.

3. The apparatus of claim 1, further comprising:
a memory, operatively coupled to the tracing message processing module, for storing information indicative of the information transfer capability,
wherein the tracing message processing module is further operable to determine the information transfer capability for the communication link by accessing the memory.

4. The apparatus of claim 1, further comprising:
a tracing message generator operatively coupled to the interface and operable to generate tracing messages and to send the generated tracing messages to other apparatus through the interface; and
a response processing module operatively coupled to the interface and operable to process responses to the generated tracing messages, by determining an information transfer capability of a communication path being traced by a generated tracing message based on received responses to the generated tracing message that include indications of information transfer capabilities of communication links comprising the communication path.

5. The apparatus of claim 1, wherein the tracing messages comprise Linktrace Messages (LTMs), wherein the response comprises a Linktrace Reply (LTR), and wherein the indication of the information transfer capability comprises a Type-Length-Value (TLV) triplet of the LTR.

6. The apparatus of claim 2,
wherein the tracing message is associated with one of a plurality of independently controlled domains of the communication system, and
wherein the tracing message processing module is further operable to determine whether the further tracing message is to be associated with a different domain of the plurality of domains, and to generate as the further tracing message a further tracing message associated with the different domain where the further tracing message is to be associated with the different domain.

7. The apparatus of claim 6,
wherein the received tracing message comprises an indication of the one of the plurality of domains, and
wherein the tracing message processing module is further operable to include, in the further tracing message, an indication of the different domain where the further tracing message is to be associated with the different domain.

8. The apparatus of claim 7, wherein the tracing message processing module is further operable to include, in the further tracing message, an indication that no response is to be made to the further tracing message where the further tracing message is to be associated with the different domain.

9. The apparatus of claim 2,
wherein the tracing message processing module is associated with one of a plurality of independently controlled domains of the communication system, and
wherein the tracing message processing module is further operable to determine whether the received tracing message was based on a tracing message associated with a different domain of the plurality of domains, and to include, in the further tracing message, the indication of the information transfer capability, where the further tracing message is to be forwarded to other apparatus and the received tracing message was based on a tracing message associated with a different domain, the tracing message processing module generating and sending no response to the received tracing message where the received tracing message was based on a tracing message associated with a different domain of the plurality of domains.

10. The apparatus of claim 9, wherein the tracing message processing module is further operable to include the indication of the information transfer capability in the further tracing message where the information transfer capability is less than an information transfer capability reflected in an indication of information transfer capability in the received tracing message.

11. A communication system comprising:
an apparatus as defined in claim 1, implemented at each of a plurality of sites; and
at least one apparatus operable to generate a tracing message.

12. The communication system of claim 11, wherein the at least one apparatus comprises a Maintenance association End Point (MEP), and wherein each apparatus implemented at the plurality of sites comprises a MEP or a Maintenance Intermediate Point (MIP).

13. A method comprising:
receiving a tracing message for tracing a communication path in a communication system; and
generating a response to the received tracing message, the response including an indication of an information transfer capability of a communication link that comprises the communication path being traced by the received tracing message.

14. The method of claim 13, further comprising:
determining whether a further tracing message based on the received tracing message is to be forwarded; and
forwarding a further tracing message based on the received tracing message where a further tracing message is to be forwarded.

15. The method of claim 13, further comprising:
generating a tracing message for tracing another communication path;
receiving replies to the generated tracing message, the received replies including indications of information transfer capabilities of communication links comprising the other communication path; and
determining from the received replies an information transfer capability of the other communication path.

16. The method of claim 13, wherein the tracing message comprises a Linktrace Message (LTM), wherein the response comprises a Linktrace Reply (LTR), and wherein the indication of the information transfer capability comprises a Type-Length-Value (TLV) triplet of the LTR.

17. The method of claim 14, wherein the tracing message is associated with one of a plurality of independently controlled domains of the communication system, the method further comprising:
determining whether the further tracing message is to be associated with a different domain of the plurality of domains; and
generating, as the further tracing message, a further tracing message associated with the different domain where the further tracing message is to be associated with the different domain.

18. The method of claim 17, wherein the received tracing message comprises an indication of the one of the plurality of domains, the method further comprising:
including, in the further tracing message, an indication of the different domain where the further tracing message is to be associated with the different domain.

19. The method of claim 18, further comprising:
including, in the further tracing message, an indication that no response is to be made to the further tracing message where the further tracing message is to be associated with the different domain.

20. The method of claim 14, implemented in apparatus associated with one of a plurality of independently controlled domains of the communication system, the method further comprising:
determining whether the received tracing message was based on a tracing message associated with a different domain of the plurality of domains; and
including, in the further tracing message, the indication of the information transfer capability, where the further tracing message is to be forwarded and the received tracing message was based on a tracing message associated with a different domain,
a response to the received tracing message being generated only where the received tracing message was not based on a tracing message associated with a different domain of the plurality of domains.

21. An apparatus comprising:
an interface operable to enable the apparatus to exchange tracing messages for tracing communication paths in a communication system; and
a tracing message processing module operatively coupled to the interface and operable to process a tracing message, received through the interface, by determining with which one of a plurality of independently controlled domains of the communication system the received tracing message is associated, determining whether a further tracing message based on the received tracing message is to be forwarded to other apparatus and is to be associated with a different domain of the plurality of domains, and generating as the further tracing message a further tracing message based on the received tracing message and associated with the different domain where a further tracing message is to be forwarded and is to be associated with the different domain.

22. The apparatus of claim 21,
wherein the received tracing message comprises an indication of the one of the plurality of domains, and
wherein the tracing message processing module is operable to include, in the further tracing message, an indication of the different domain where the further tracing message is to be forwarded and is to be associated with the different domain.

23. The apparatus of claim 22, wherein the tracing message processing module is further operable to include, in the further tracing message, an indication that no response is to be made to the further tracing message where the further tracing message is to be associated with the different domain.

24. The apparatus of claim 21,
wherein the tracing message processing module is associated with one of the plurality of domains, and
wherein the tracing message processing module is further operable to determine whether the received tracing message was based on a tracing message associated with a different domain than the tracing message processing module, to include, in the further tracing message, an indication of an information transfer capability of a communication link that is associated with the apparatus and comprises a communication path being traced by the received tracing message, where the further tracing message is to be associated with a different domain and the received tracing message was based on a tracing message associated with a different domain than the tracing message processing module, and to generate and send through the interface a response to the received tracing message, the response comprising the indication, where the received tracing message was not based on a tracing message associated with a different domain than the tracing message processing module.

25. The apparatus of claim 24, wherein the tracing message processing module is further operable to include the indication of the information transfer capability in the further tracing message where the information transfer capability is less than an information transfer capability reflected in an indication of information transfer capability in the received tracing message.

26. A communication system comprising:
an apparatus as defined in claim 21, implemented at each of a plurality of sites; and
at least one apparatus operable to generate a tracing message,
wherein the at least one apparatus comprises a Maintenance association End Point (MEP), and wherein each apparatus implemented at the plurality of sites comprises a MEP or a Maintenance Intermediate Point (MIP).

27. A method comprising:
receiving a tracing message for tracing communication paths in a communication system, the tracing message being associated with one of a plurality of independently controlled domains of the communication system;
determining whether a further tracing message based on the received tracing message is to be forwarded and is to be associated with a different domain of the plurality of domains; and
generating as the further tracing message a further tracing based on the received tracing message and associated with the different domain where a further tracing message is to be forwarded and is to be associated with the different domain.

28. The method of claim 27, wherein the received tracing message comprises an indication of the one of the plurality of domains, the method further comprising:
including, in the further tracing message, an indication of the different domain where the further tracing message is to be forwarded and is to be associated with the different domain.

29. The method of claim 28, further comprising:
including, in the further tracing message, an indication that no response is to be made to the further tracing message where the further tracing message is to be forwarded and is to be associated with the different domain.

30. The method of claim 28, implemented in apparatus associated with one of the plurality of domains, the method further comprising:
determining whether the received tracing message was based on a tracing message associated with a different domain than the apparatus,
including, in the further tracing message, an indication of an information transfer capability of a communication link that is associated with the apparatus and comprises a communication path being traced by the received tracing message, where the further tracing message is to be forwarded and is to be associated with a different domain and the received tracing message is associated with a different domain than the apparatus; and
generating and sending a response to the received tracing message, the response comprising the indication, where the received tracing message was not based on a tracing message associated with a different domain than the apparatus.
